(19) United States
(12) Patent Application Publication
(10) Pub. No.: US 2013/0118596 A1
(43) Pub. Date: May 16, 2013

(54) GAS FLOW SYSTEM, DEVICE AND METHOD

(71) Applicant: THOMAS NEAL HORSKY, BOXBOROUGH, MA (US)

(72) Inventor: THOMAS NEAL HORSKY, BOXBOROUGH, MA (US)

(21) Appl. No.: 13/674,399

(22) Filed: Nov. 12, 2012

Related U.S. Application Data
(60) Provisional application No. 61/629,058, filed on Nov. 12, 2011.

(51) Int. Cl. F16K 17/00

(52) U.S. Cl. CPC F16K 17/00
USPC 137/12; 137/505

(57) ABSTRACT

A gas flow device and method are provided for controlling the flow of gases into a process chamber. The gas flow device includes one of more pressure reduction stages, a metering valve, a pressure gauge, and a control system. the gas flow device provides a steady and stable flow of gas from a gas source to a process chamber held at sub-atmospheric pressure.

### CROSS-REFERENCE TO RELATED APPLICATIONS

The present application claims priority to co-pending Provisional Patent Application No. 61/629,058 filed on Nov. 12, 2011, entitled “Gas Flow Device”; that application being incorporated herein, by reference, in its entirety.

### BACKGROUND OF THE INVENTION

1. Field of the Invention

The invention relates to a gas flow device and, more particularly, to a gas flow device for controlling the flow of gases from a gas source into a process chamber.

2. Description of the Related Art

Many of the processes used in the manufacturing of integrated circuits are performed at sub-atmospheric pressures in dedicated systems called process chambers. These systems typically incorporate vacuum pumps to maintain a desired process pressure range, and are coupled to a gas distribution system which supplies the gaseous chemicals required for specific processes. Such processes include deposition (CVD, PECVD, LPCVD, ALD, or PVD, for example) or ion implantation (beam line ion implantation, plasma doping ion implantation, or plasma immersion ion implantation). Gaseous chemicals are typically stored in superatmospheric pressure cylinders, each having a dedicated pressure regulator. In certain cases, cylinders may be at sub-atmospheric pressure (as in so-called Safe Delivery System® products). Additionally, certain materials, such as organo-metallic compounds, may be sublimated or otherwise gasified from either solid or liquid materials.

Gases are typically fed into a gas distribution manifold for communication to a specific process chamber or chambers on demand. This manifold is connected to one or more outlets which contain metering valves to control the flow of gaseous material to its point of use. The characteristics of this metering valve largely determines the instantaneous downstream pressure of the process chamber. An ideal gas metering technology would enable process pressure accuracy (match of actual process pressure to user set point value), repeatability, stability, and fast response to fluctuations in upstream pressure, also an important aspect of stability.

The most common type of metering valve for many applications is the mass flow controller (MFC). MFC's are readily available in multiple flow ranges, are relatively inexpensive, and have a small footprint. Conventional MFC's regulate flow by measuring the heat transferred to a volume of gas by a heater element; they are therefore calibrated for the heat capacity of a specific gas. This technology has certain inherent limitations, particularly for low flow (e.g., 0.2 sccm to 10 sccm) and low process pressure (e.g., 0.1 milliTorr to 100 milliTorr) applications, in that it is subject to drift, and is inherently slow, so that thermally-based MFC's cannot properly adapt to fast transients in inlet pressure. Therefore, a need exists for an improved gas flow device with fast transient response and improved stability.

U.S. Pat. No. 7,723,700 to Horsky et al., (“the '700 patent”) discloses a vapor delivery system for delivering a steady flow of sublimated vapor to a vacuum chamber. The vapor delivery system of the '700 patent includes a vaporizer of solid material, a mechanical throttling valve and a pressure gauge followed by a vapor conduit to the vacuum chamber. The vapor flow rate is determined by both the temperature of the vaporizer and the setting of the conductance of the mechanical throttle valve located between the vaporizer and the vacuum chamber. The temperature of the vaporizer in the '700 patent is determined by closed-loop control to a set-point temperature and the mechanical throttle valve is electrically controlled, e.g., the valve position is under closed-loop control (i.e., a feedback loop) based on the output of the pressure gauge. Additionally, according to col. 12 of the '700 patent, lines 59-63 states that the pressure at the outlet of the vaporizer (i.e., upstream of the throttle valve) is about 65 milliTorr. Thus, the pressure at the inlet of the control device of the '700 patent is much lower than is found at the outlet of a typical gas source or tank.

What is needed is a system device and method that can deliver a steady gas flow with gas received from a tank or a gas source at a typical or standard tank pressure. What is additionally needed is a system, device and method for delivering a steady gas flow that does not require closed-loop control of a temperature of the device to regulate gas flow. What is further needed is a gas flow device that can be easily interposed into the gas flow path between the gas source and a process chamber to improve stability of the gas flow.

### SUMMARY OF THE INVENTION

In order to overcome the above-mentioned disadvantages of the heretofore-known devices of this general type, it is accordingly an object of the invention to provide a system for controlling the flow of gas from a gas source to a process chamber. A gas flow device is interposed into the gas flow between the gas source and the process chamber. In accordance with one particular embodiment of the invention, the gas flow device includes one or more pressure reduction devices, a controllable valve, a pressure gauge, and a control system that controls the valve in response to information received from the pressure gauge. The gas flow device provides a stable inlet pressure to the process chamber, thus minimizing pressure instabilities in the process chamber.

Additionally, a method is provided for producing a stable and well-defined pressure through closed-loop control of an adjustable valve or throttle valve using data obtained from a downstream pressure gauge. In one particular embodiment of the invention, a set point for a desired pressure, as measured at the downstream pressure gauge is selected. The measured pressure signal from the downstream pressure gauge is fed to the input of a control system, which compares the measured pressure signal with the set point value. Depending on the difference between the measured pressure signal and the set point value, the control system produces an error signal, which is used to generate an output or control signal to the adjustable value, to adjust the position of a throttling element of the valve in order to minimize the magnitude of the error signal.

Although the invention is illustrated and described herein as embodied in a gas flow system, device and method, it is nevertheless not intended to be limited to the details shown, since various modifications and structural changes may be made therein without departing from the spirit of the invention and within the scope and range of equivalents of the claims.

The construction of the invention, however, together with the additional objects and advantages thereof will be best understood from the following description of the specific embodiments when read in connection with the accompanying drawings.

### BRIEF DESCRIPTION OF THE SEVERAL VIEWS OF THE DRAWING

FIG. 1 is a simplified block diagram of a gas flow device in accordance with one particular embodiment of the present invention;

FIG. 1A is a schematic diagram of one particular embodiment of the gas flow device of FIG. 1;

FIG. 2 is a simplified diagram of an ion source for an ion implanter in accordance with one particular embodiment of the present invention;

FIG. 3 illustrates a gas flow device in accordance with one particular embodiment of the present invention;

FIG. 4 illustrates a gas flow device in accordance with another particular embodiment of the present invention;

FIG. 5 illustrates a gas flow device in accordance with a further particular embodiment of the present invention;

FIG. 6 illustrates a gas flow device in accordance with still another particular embodiment;

FIG. 7 is a flow chart showing a method for controlling gas flow in accordance with one particular embodiment of the present invention.

### DESCRIPTION OF THE PREFERRED EMBODIMENTS

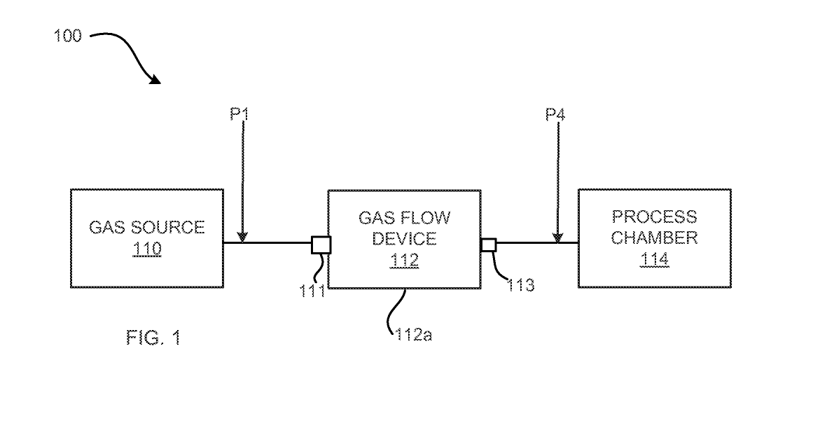

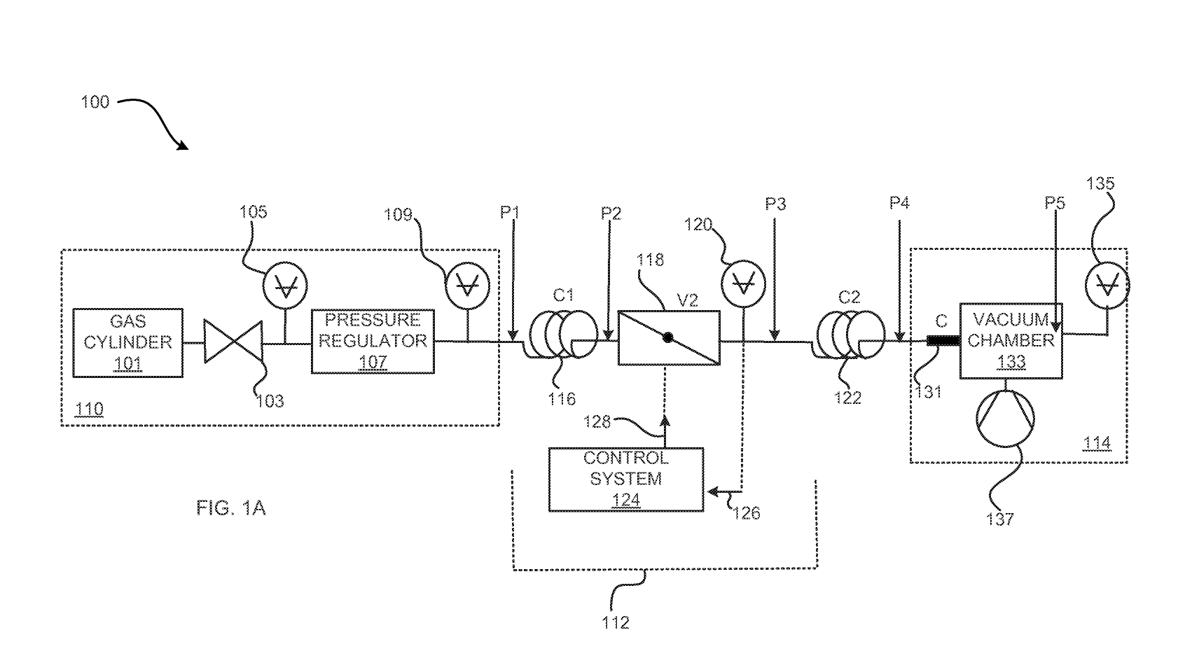

Referring now to FIGS. 1 and 1A there is shown a system 100 for controlling the flow of gas from a gas source 110 to a process chamber 114. The pressure P5 within the process chamber 114 is determined by the fixed conductance C of the inlet 131 and the pumping speed of the pump 137. That is, there is a one-to-one correlation between inlet pressure P4 and process chamber pressure P5. Thus, pressure instabilities in the process chamber 114 will be minimized if the inlet pressure P4 is stable. Conversely, if inlet pressure P4 is not stable, the process chamber pressure P5 will likely not be stable. In accordance with the present invention, a gas flow device 112 is provided in the system 100 to produce a stable inlet pressure P4. When connected to a process chamber 114 held at sub-atmospheric pressure, the gas flow device 112 provides a steady flow of gas such that the stability of the flow is superior to many commercially available flow control devices.

In accordance with the present invention, a gas flow device 112 is disposed in the flow path between the gas source 110 and the process chamber 114. In one particular embodiment of the invention, the gas flow device 112 can be provided as a single or stand-alone unit encompassed in a housing 112a. Pressurized gas is received into the gas flow device 112 from the outlet of gas source 110, via a standard gas line connector 111. In one particular embodiment of the invention, the pressure P1 at the outlet of the gas source 110 is a standard or typical tank pressure, such as, but not limited to, 5 PSIG. The gas flow device 112 reduces the gas pressure such that gas exits a gas line connector 113, connected to an inlet of the process chamber 114, at a reduced pressure P4.

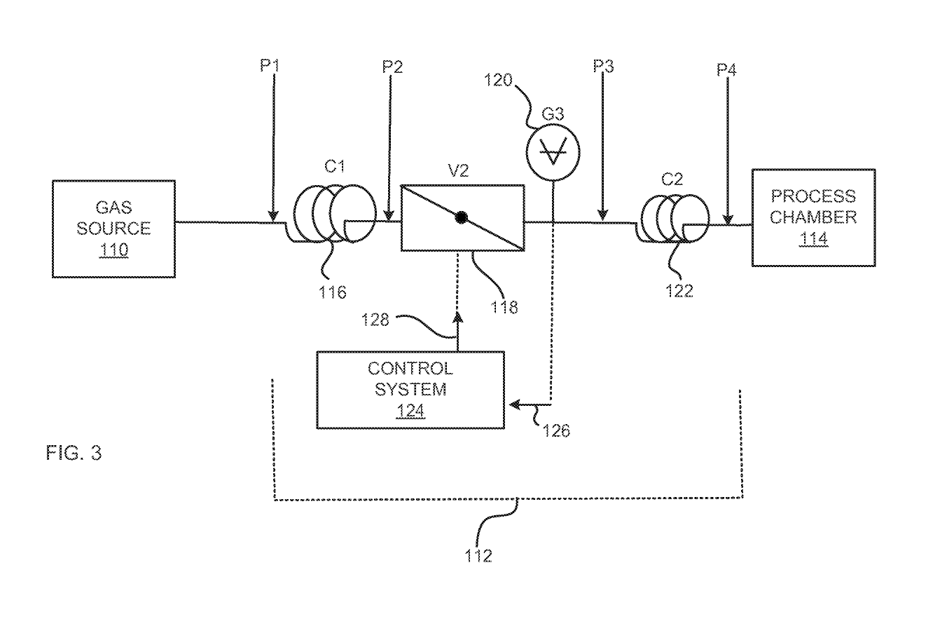

Referring now to FIGS. 1, 1A and 3, gas flow device 112 of the present invention establishes a well-defined pressure at the inlet 131 of a process chamber 114 including a vacuum chamber 133 which is actively pumped. In accordance with one particular embodiment of the invention, the gas flow device 112 includes one or more pressure reduction devices or conductance limitations 116, 122 having a defined or variable conductance, a controllable valve 118, such as a throttle valve, a pressure gauge 120, and a control system 124. The controllable valve 118 can be of any desired type of valve that can be any dynamically adjustable and electrically controllable, such as a butterfly valve, pendulum valve, or linear gate valve, for example. Pressure reduction devices 116, 122 can have one of many different constructions, including, but not limited to, long thin tubes, baffles, apertures, or a combination thereof. Downstream of gas source 110, the gas enters the gas flow device 112 at a pressure P1. In the gas flow device 112, the gas pressure is further reduced from P1 to a pressure P2 by pressure reduction device 116, which has a conductance C1. In one particular embodiment of the invention, the pressure reduction device 116 is configured to reduce the pressure P1 to a pressure P2 that is between 1 Torr and 100 Torr.

In the particular embodiment of FIGS. 1A and 3, a gas source 110 produces a regulated flow of gas at a delivery pressure P1 to the downstream system. In one particular embodiment of the invention, the delivery pressure P1 is on the order of 5 psig, as is common in the industry for high-pressure cylinders having one- or two-stage regulators. Gas source 110 can be provided in many different configurations; however, for illustrative purposes only, the present embodiment shows a high pressure cylinder 101 followed by a shutoff valve 103 and pressure gauge 105. Downstream of gauge 105 is a pressure regulator 107 which regulates pressure from cylinder pressure to about 5 psig, as is common in the semiconductor equipment industry. The outlet pressure of regulator 107 is measured by a gauge 109, which reports the pressure P1 at the outlet of regulator 107.

Downstream of the pressure regulator 107 of the gas source 110, the pressure is further reduced to a pressure P2 by pressure reduction device 116, which is a conductance limitation having a conductance C1. For example, the pressure reduction device 116 is configured in one embodiment of the invention to have a conductance C1, such that the pressure P2 may be between 1 Torr and 100 Torr. In one embodiment of the invention, the pressure reduction device 116 may be a long, narrow pipe (illustrated as a ‘loop’ in FIG. 1A) which has a fixed conductance C1. However, this is not meant to be limiting, as other embodiments may be provided that provide a variable conductance C1 (such as using a variable-conductance valve), as desired.

An electrically-adjustable or controllable metering or throttle valve (V2) 118 is disposed downstream of the pressure reduction device 116. The valve 118 is selected to be a high-conductance valve having a dynamic range of between 3 and 100, for example. That is, when in a flow condition, valve 118 will reduce the pressure P2 by between 3 and 100 times, to a pressure P3. The pressure P3 downstream of the valve 118 is measured by the pressure gauge (G3) 120. pressure gauge 120 is, preferably, selected to measure the pressure P3 with excellent reproducibility and low signal-to-noise ratio. Pressure gauge 120 can be selected to provide optimized performance in the useful pressure range P3. This is of note since gauges are typically configured to operate best within a given pressure range. The output signal from the pressure gauge 120 is interpreted by a control system 124 to adjust the conductance of the adjustable valve 118. In one particular embodiment of the invention, the valve 118 is electrically adjustable, for example by an electric motor which moves a throttling element of the valve 118 to set a particular conductance of the valve 118.

The control system 124 can include a computer, microprocessor and/or microcontroller configured by software stored in memory and executable by the computer, microprocessor and/or microcontroller to execute the steps of the method discussed herein. Alternately, the control system 124 can include hardware hardwired to perform the steps of the method of the invention. In one particular embodiment of the invention, the control system 124 is configured by software and/or hardware to receive a pressure value for the pressure P3 from the pressure gauge 120 at an input 126 to the control system 124 and process the pressure value to control the state of, and correspondingly the conductance of, the adjustable valve 118, based on an output 128 from the control system 124.

Downstream of the pressure gauge 120 is another pressure reduction device 122 having a conductance C2. In the present preferred embodiment, the conductance C2 is a fixed conductance C2, although a variable conductance device could be used, if desired. As can be seen from FIG. 1A, the outlet of the pressure reduction device 122 couples directly to the inlet 131 of the process chamber 114, thus providing gas at a pressure P4 to the inlet 131 of the process chamber 114.

By selecting appropriate conductance values C1 and C2, a broad range of process chamber pressures can be produced. The values for C1 and C2 can be optimized to deliver a desired range of pressures P4 to the process chamber 114. Additionally, the conductance values C1 and C2 can be selected before assembly of the gas flow device unit, so as to permit operation in a pre-selected range of gas pressures. If desired, the gas flow device 112 can be configured to permit the pressure reduction elements 116, 122 to be demountable from the gas flow device assembly, and replaced by different fixed or variable pressure reduction elements having different conductance values or ranges.

According to the present invention, four distinct pressure values can be defined in connection with the gas flow device 112:
P1: Delivery pressure of regulated gas source;
P2: Pressure downstream of pressure reducer C1;
P3: Pressure downstream of V2; and
P4: Inlet pressure to process chamber 114, downstream of the conductance C2.

A fifth pressure, P5, can be found in the process chamber 114. The purpose of gas flow device 112 is to provide a variable, but stable, pressure P4 at its outlet, which is the inlet of the process chamber 114. One exemplary configuration of a process chamber 114 will be described in connection with FIG. 1A, for illustration purposes only. Other configurations for the process chamber 114 may be used, as desired. Referring now to FIG. 1A, a set of basic elements provided in virtually any process chamber are shown. The process chamber inlet 131, having a conductance C, is directly coupled to a vacuum chamber 133, typically a vacuum chamber wherein a particular process occurs. Vacuum chamber 133 is connected to vacuum pump 137, and the pressure within the vacuum chamber 133 is monitored by vacuum gauge 135. In many cases, a wafer or substrate is inserted into vacuum chamber 133 and gases are introduced in desired combinations to allow a specific process to be applied to the substrate or wafer. These processes are typically conducted at sub-atmospheric pressure (i.e., less than 760 Torr), and, in many cases, may occur at pressures below 10 Torr, below 1 Torr, or in certain cases below 1 milliTorr. Some common vacuum-based processes include deposition (CVD, PECVD, LPCVD, ALD, or PVD, for example) or ion implantation (beam line ion implantation, plasma doping ion implantation, or plasma immersion ion implantation). Gaseous chemicals are typically stored in super-atmospheric pressure cylinders, each having a dedicated pressure regulator. In certain cases, cylinders may be at sub-atmospheric pressure (as in so-called Safe Delivery System® products).

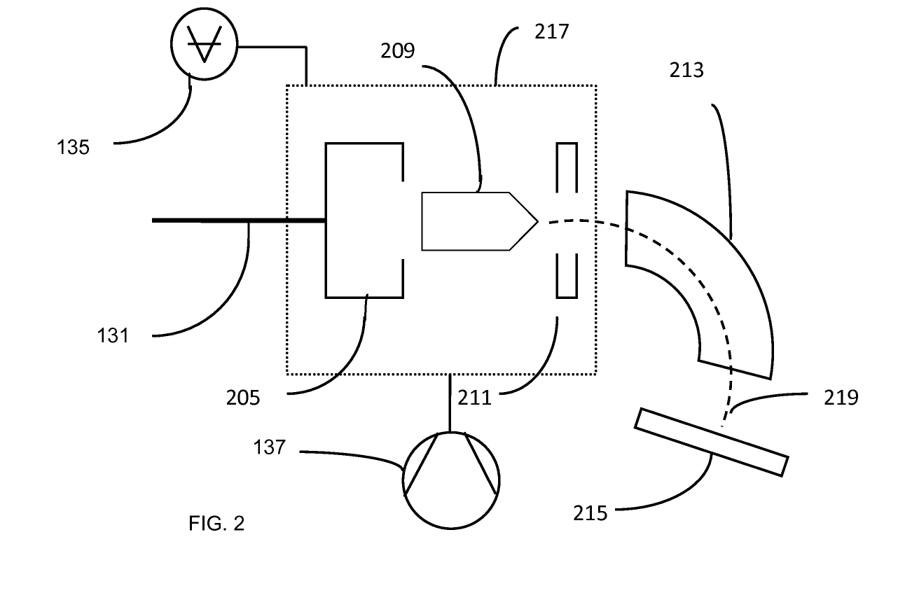

Although FIGS. 1 and 1A show a single gas source 110 and a single gas flow device 112, this is not meant to be limiting. Rather, if desired, several gas sources 110 can be provided, with each gas source 110 being coupled to one of a plurality of individual gas flow devices 112, which can then provide user-selected gas flows to a gas manifold (not shown in FIG. 1) connected to the process chamber inlet 131, so as to provide desired gas mixtures to process chamber 114. In some cases, the process chamber 114 may be a plasma chamber, and the substrate or wafer to be processed is located elsewhere. The plasma from the process chamber 114 may be communicated to a vacuum chamber 133 located elsewhere, which contains the wafers or substrates to be processed. In such a case, other components would be included as part of the process chamber 114, such as, but not limited to, a beam line ion implanter, and the vacuum chamber 133 would include an ion source. One such ion source is shown more particularly in FIG. 2.

Referring now to FIGS. 1A and 2, in an ion implanter, one or more gases at individual pressures P4 may flow through the inlet 131, having a conductance C, to the ionization chamber of an ion source (FIG. 2), which would form part of the vacuum chamber 133 of FIG. 1A. In the present embodiment of the invention, gases flow from a gas flow device 112 or a manifold (not shown) through the inlet or conductance 131, and into ionization chamber 205. The gases are formed into a plasma within ionization chamber 205 and positive ions 209 from the plasma are extracted from ionization chamber 205 by an extraction electrode 211. Elements 205, 209, and 211 are enclosed within a vacuum chamber 217 which is held at high vacuum (below 1×10−4 Torr) by vacuum pump 137, and the vacuum is monitored by the vacuum gauge 135. Ion source ionization chamber 205 is typically held at a high positive voltage (between 100V and 100 kV) relative to extraction electrode 211 and vacuum chamber 217, so that the ions are extracted and formed into an ion beam 219 by strong electric fields. The ion beam 219 is then transported to a wafer or substrate 215 by the magnetic fields produced by a transport electromagnet 213. Elements 213, 219, and 215 also held at a high vacuum level similar to that of vacuum chamber 217, although the additional vacuum system elements such as pumps and chambers are not shown in FIG. 2.

Typically, transport magnet 213 disperses ion beam 219 according to the mass-to-charge ratio of the ions, such that unwanted ions can be prevented from reaching the wafer or substrate 215 by a simple aperture plate located between transport magnet 213 and wafer or substrate 215. The gas pressure within ionization chamber 205 is typically between 0.1 mTorr and 10 mTorr, depending on the type of ion source used by the ion implanter. In certain cases, however, the pressure may be substantially higher or lower. Although the pressure within the ionization chamber 205 of the ion source is in the milliTorr range, the pressure within the surrounding vacuum chamber 217 is typically at least an order of magnitude lower. This reduced pressure is meant to preserve the ion beam during transport, and also to maintain high electric fields without unwanted electrical discharges.

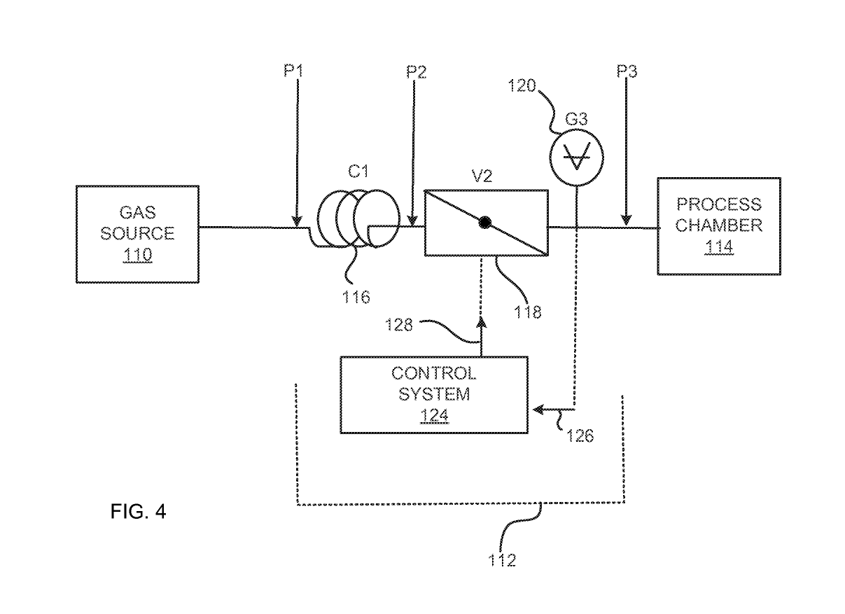

Referring now to FIGS. 1 and 4, there is shown an alternate embodiment of a gas flow device 112 for use in the system 100. The device 112 of FIG. 4 is similar in most respects to the device 112 of FIGS. 1A and 3, with like reference numbers representing like elements, except that the pressure reduction device or 122 has been omitted from between the throttle valve 118 and the inlet to the process chamber 114.

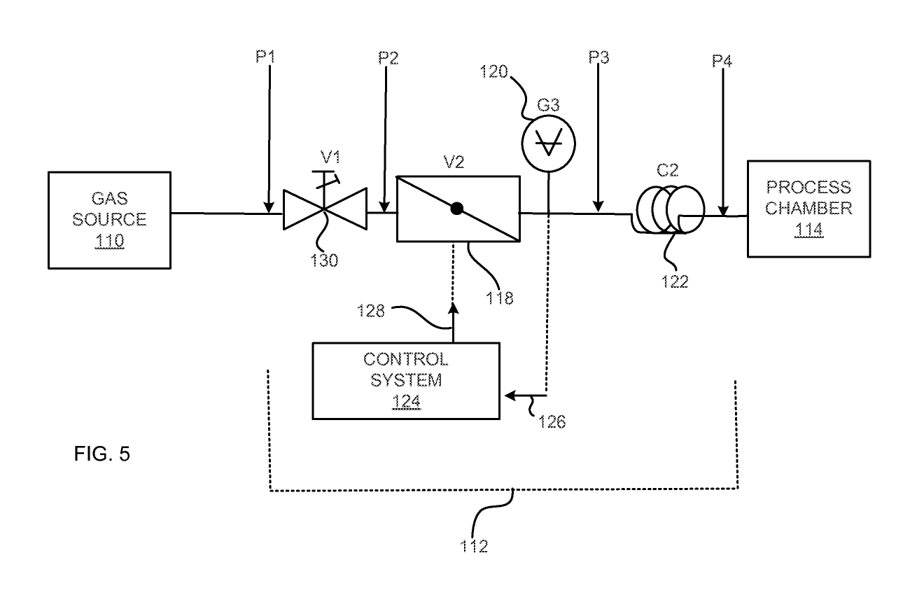

FIG. 5 shows a further embodiment of a gas flow device that can be used as the gas flow device 112 in the system 100 of FIG. 1. The gas flow device of FIG. 5 differs from the previous embodiments in that a variable-conductance valve (V1) 130 is used instead of the pressure reduction device 116 between the gas source 110 and the throttle valve 118. The variable-conductance valve 130 can be any type of variable conductance valve, such as, a needle valve, a ball valve or other type of metering valve, as desired. This provides flexibility to accommodate a broader range of gas source pressures P1 than does a fixed conductance, such as is shown in connection with FIG. 3.

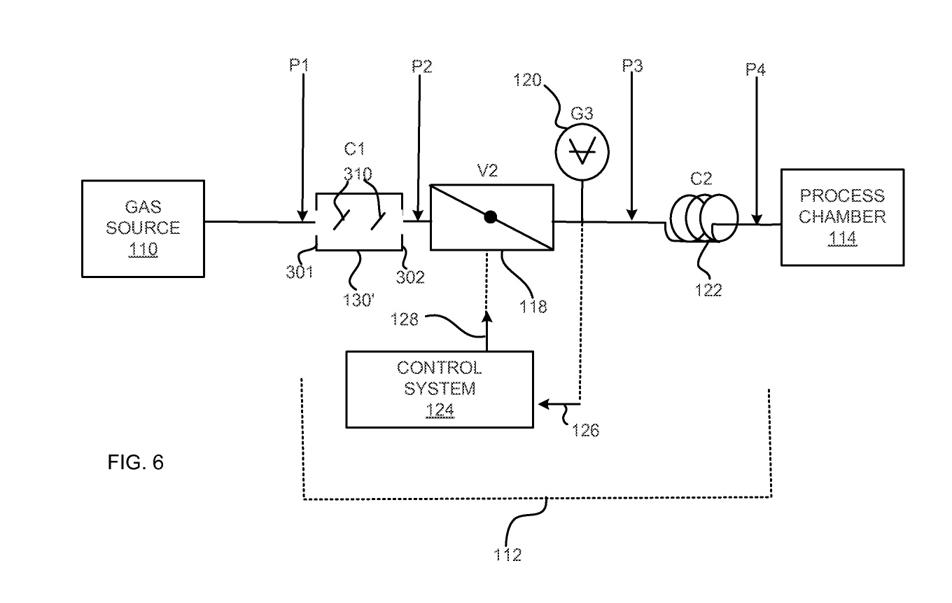

FIG. 6 shows another gas flow device in accordance with another embodiment of the invention. As can be seen, the gas flow device of FIG. 6 includes a pressure reduction device 130′, having a fixed conductance C1, that limits the conductance between gas source 110 and throttle valve 118. Pressure reduction device 130′ is shown as a long tube having inlet aperture 301 and exit aperture 302, and interior baffles 310, in order to illustrate that a conductance-limiting element of any desired geometric form may be used in place of, or in addition to, the long, thin tube or loop illustrated in FIGS. 3 and 4.

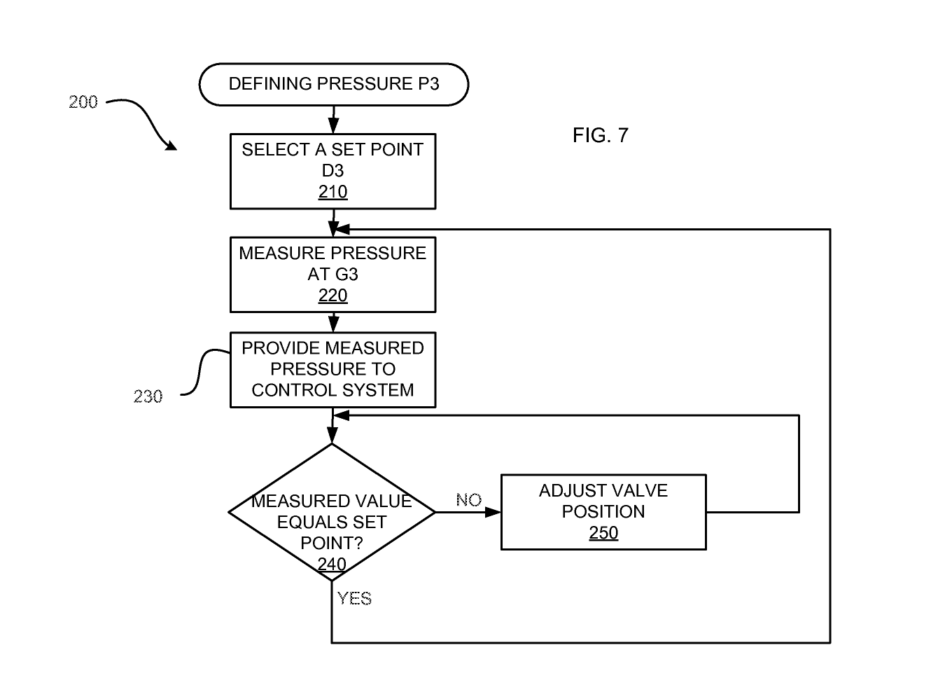

One goal of this invention is to produce a stable and well-defined pressure P3. This is accomplished through closed-loop control of throttle valve 118 using data obtained from the downstream pressure gauge 120. One particular method 200 for setting the pressure P3 will now be described in connection with FIG. 7. First, a set point D3 is selected for a desired pressure value for the pressure P3, as measured by the pressure gauge 120. Step 210. In one particular embodiment of the invention, the set point D3 is selected by a user. The pressure gauge 120 measures a pressure P3 of the gas output downstream of the valve 118. Step 220. An output signal representative of the value of the measured pressure P3 is provided to the control system (124 of FIG. 1A), where it is used to generate an error signal representing a difference between the measured value and the set point value D3. Step 230. Thus, if the measured value is unequal to the set point value D3, the system sets about adjusting the throttle valve to minimize the error signal. Steps 240-250. The error signal, or a signal representing the error signal is used to adjust a position of a throttling element of the adjustable valve (118 of FIG. 1A), such that the magnitude of the error signal is minimized. As discussed hereinabove, this control methodology requires that the valve (118 of FIG. 1A) be electrically adjustable, for example by an electric motor which moves a throttling element of the valve (118 of FIG. 1A) to control the conductance of the valve (118 of FIG. 1A). One such throttle valve that can be used to perform closed-loop throttle position control based on the output of a pressure gauge include, for example, a butterfly valve available from MKS Instruments, North Andover, Mass. Other types of throttle valves such as pendulum valves, linear gate valves, and others are also commercially available.

Referring now to FIGS. 1 and 1A, in accordance with the present invention, once the delivery pressure from the gas source P1 and the desired process chamber pressure P5 are given, and the actively pumped process chamber inlet conductance C and the volumetric flow of process gas Q is known, then the appropriate pressure value of P2, and the pressure ranges of pressures P3 and P4 can be calculated. These calculations will determine the appropriate values of the conductances C1 and C2. Conductances C1 and C2 can be readily tailored for different ranges of pressures P1 and P5, so that the same basic flow control architecture (FIG. 1) can be preserved for a number of discrete pressure ranges. That is, the conductance C1 is selected to adjust the (static) gas source pressure, while the conductance C2 is selected to adjust the (static) inlet pressure P4 to the process chamber 114. The dynamic range of the novel gas flow device 112 is therefore determined by the dynamic range of the adjustable valve 118. In other words, the values selected for C1 and C2 define the pressure range within which the adjustable valve 118 operates in order to produce a desired, stable output pressure P4. Note that, high values can be chosen for the conductances C1 or C2 (i.e., as though there were no pressure reducers 116, 122), if conditions so demand. A given set of conductance values C1 and C2 simply determine the dynamic range of pressure P4 delivered to the inlet 131 of the process chamber 114. Such a determination can be useful in optimizing the gas flow device 112 to operate in a desired range of pressures, either dynamically, during the operation of the device 112, or when designing and/or constructing the device 112.

The following examples serve to illustrate the utility of the invention only, and are not meant to limit the invention to only the values given in the examples. The effects of turbulence, viscous versus molecular flow, and transitions between flow regimes will depend on the properties and geometries of the components which are selected to provide the desired characteristics of C1, C2 and V2, as described herein, and indeed how they are physically coupled.

### EXAMPLE 1

An implanter ion source receiving a volumetric flow of process gas of 2 sccm at an ion source pressure of 1 mTorr. The gas inlet to the ion source is a long thin pipe with a conductance C of 5×10⁻² L/s. The gas source is a high-pressure cylinder regulated down to 5 psig.

P1: 5 psig

P5: 1 mTorr

C: 5×10⁻² L/s

Q: 2 sccm=2.5×10⁻² Torr-L/s.

We use the relation

C=Q/(P4−P5) (1)

to determine P4 from a known C and Q. Thus,

P4=Q/C+P5. (2)

For such a small conductance C, the pressure drop is substantial, so that P5<<P4. Thus,

P4˜Q/C. (3)

Therefore, P4 is about 0.5 Torr. Choosing a finite value of C2 will only serve to increase the operating pressure of V2. For this example, assume that C2 is large, so that P3˜P4. This embodiment is shown in FIG. 4; C2 is absent, and the outlet of V2 couples directly to C.

If V2 is a throttle valve with a useful dynamic range of 20, then P2 (the inlet pressure to V2) can be between about 10 Torr and 0.5 Torr. This range is somewhat dependent on the finite conductance of V2 in its fully open position, but we note that in practice, the conductance dynamic range of V2 can be accurately measured.

With the range of P2 thus defined, C1 is required to reduce the pressure from 5 psig (approximately 1000 Torr) to approximately 5 Torr (the middle of V2's useful control range for P2). This factor of 200 in pressure reduction can be accomplished by either a variable-conductance valve, for example if adjustability is required, or a fixed pressure reducer, such as a long thin pipe as shown in FIG. 3, or indeed a round pipe with entrance and exit apertures, as shown in FIG. 6.

Using the form of Equation (1), we find that the required conductance for C1 is:

C1=Q/(P1−P2). (4)

Inserting the values Q=2.5×10⁻² Torr-L/s, P1=1000 Torr, and P2=5 Torr, we have

C1˜2.5×10⁻⁵ L/s. (5)

### EXAMPLE 2

Implanter ion source receiving a volumetric flow of process gas of 0.2 sccm with ion source pressure of 1 mTorr. The gas inlet to the source is a long thin pipe with a conductance of 5×10⁻² L/s. The gas source is sub-atmospheric gas cylinder providing a delivery pressure of 500 Torr.

P1: 500 Torr

P5: 1 mTorr

C: 5×10⁻² L/s

Q: 0.2 sccm=2.5×10⁻³ Torr-L/s.

This example is similar to Example 1 except for the sub-atmospheric delivery pressure of the gas source and the volumetric flow, so we will use the embodiment of FIG. 4. Following the same method of calculation, we find:

P4=P3˜Q/C (6)

P3=50 mTorr. (7)

If V2 is a throttle valve with a useful dynamic range of 20, then P2 can be between about 1 Torr and 50 mTorr. Thus, we choose P2 to be centered about the useful range of V2:

P2=0.5 Torr. (8)

Again using Equation (1), we find that the required conductance for C1 is:

C1=Q/(P1−P2). (9)

Inserting the values Q=2.5×10⁻³ Torr-L/s, P1=500 Torr, and P2=0.5 Torr, we have

C1˜5×10⁻⁶ L/s.

### EXAMPLE 3

An alternative solution to example 2 can be realized by using the embodiment of FIGS. 1A and 3 to insert a finite conductance between throttle valve V2 and chamber conductance C, which raises the required inlet pressure P2 calculated in example 2 above. From example 2 above, we have:

P1: 500 Torr

P4: 50 mTorr

P5: 1 mTorr

C: 5×10⁻² L/s

Q: 0.2 sccm=2.5×10⁻³ Torr-L/s.

For example, we can choose

C2=1×10⁻⁴ L/s,

yielding

P3=25 Torr.

Thus, V2 can operate from about 25 Torr to about 500 Torr. Selecting the approximate midpoint of this pressure range,

P2=250 Torr.

To calculate the required conductance C1 between the gas source and V2,

C1=Q/(P1−P2).

Inserting these values yields

C1=1×10⁻⁵ L/s.

Thus, we see that in this example, incorporating a finite conductance C2<C increases the required conductance of C1.

### EXAMPLE 4

Process chamber receiving a volumetric flow of process gas of 100 sccm at a process pressure of 100 mTorr. The process chamber gas inlet has a conductance of 0.5 L/s.

P1: 5 psig

P5: 100 mTorr

C: 0.5 L/s

Q: 100 sccm=1.3 Torr-L/s

Using the same approach as used in example 1, we use embodiment 2; that is, we set

P3=P4. (16)

We calculate the expected values of P3, P2, and C1:

P3=Q/C+P5. From Eq. (2),

Substituting the values above,

P3=2.7 Torr.

If we select a throttle valve V2 with a dynamic range of at least 20, then P2 should be in the approximate range 2 Torr to 40 Torr. With the range of P2 thus defined, V1 is required to reduce the pressure from 5 psig (approximately 1000 Torr) to approximately 20 Torr (in the middle of the useful control range for P2). This factor of 50 in pressure reduction can be accomplished by either a variable-conductance valve, for example if adjustability is required, or a fixed pressure reducer, such as a round pipe with entrance and exit apertures, as shown in FIG. 6, or a long thin tube, for example.

Again using Equation (1), we find that the required conductance for V1 is:

C1=Q/(P1−P2). (18)

Inserting the values Q=1.3 Torr-L/s, P2=20 Torr, and P1=1000 Torr, we have

C1˜1.3×10⁻³ L/s. (19)

Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

I claim:

1. A gas flow device for controlling the flow of gas from a gas source into a process chamber, the gas flow device comprising:
an adjustable valve disposed in a flow path between the gas source and the process chamber;
a pressure gauge disposed downstream of said adjustable valve;
a control system controlling the conductance of said adjustable valve based on an input signal from said pressure gauge, and a first pressure reduction element disposed upstream of said controllable valve, said first pressure reduction element having a conductance C1 selected based on at least one of a particular inlet gas pressure range and a desired process chamber pressure range.

2. The gas flow device of claim 1, wherein said adjustable valve is a throttle valve and said control system is configured provide an output signal to said throttle valve based on said input signal from said pressure gauge, said output signal determining a throttling position of said throttle valve.

3. The gas flow device of claim 2, wherein said throttle valve is a butterfly valve, and the position of said butterfly determines the gas conductance of said butterfly valve.

4. The gas flow device of claim 2, wherein said throttle valve is a metering valve, the setting of said metering valve determining the gas conductance of said metering valve.

5. The gas flow device of claim 1, wherein the conductance C1 of the first pressure reducing element is fixed.

6. The gas flow device of claim 1, wherein the first pressure reducing element is adjustable to vary the conductance C1.

7. The gas flow device of claim 1, further including a second pressure reduction element downstream of said adjustable valve, said second pressure reduction element having a conductance C2.

8. The gas flow device of claim 7 wherein said conductance C1 is selected to accommodate a particular gas inlet pressure range, and said conductance C2 is selected to accommodate a particular desired process chamber pressure range.

9. The gas flow device of claim 7, wherein at least one of said conductances C1 and C2 is a fixed conductance.

10. The gas flow device of claim 9, wherein both conductances C1 and C2 are fixed conductances.

11. The gas flow device of claim 10, wherein said first and second pressure reduction elements are demountable from the gas flow device and replaceable by fixed and/or variable pressure reduction elements having different conductance values.

12. The gas flow device of claim 1, further including a housing containing the pressure reduction element, adjustable valve, pressure gauge and control system, said housing including gas line connectors for connecting said gas flow device between the gas source and the process chamber.

13. A gas flow device for controlling the rate of flow of gases from a gas source to a process chamber, said gas flow device comprising:
an electrically-controllable throttle valve disposed in a flow path between the gas source and the process chamber;
a pressure gauge disposed downstream of said electrically-controllable throttle valve;
a control system controlling the conductance of said electrically-controllable throttle valve based on an input signal from said pressure gauge, and
a first pressure reduction element having a first conductance and a second pressure reduction element having a second conductance, said first and second conductance values selected to accomodate a particular inlet gas pressure range and a desired process chamber pressure range.

14. The gas flow device of claim 13, wherein said gas flow device is encompassed as a unit in a housing connectable between the gas source and the process chamber.

15. The gas flow device of claim 13, wherein said control system is configured to provide an output signal to said throttle valve based on said input signal from said pressure gauge, said output signal determining the throttling position of said throttle valve.

16. The gas flow device of claim 13, wherein said first pressure reduction element is adjustable to vary the first conductance and said second pressure reduction element is fixed producing a fixed second conductance value.

17. The gas flow device of claim 16, wherein said variable conductance element C1 is selected to accommodate a particular gas inlet pressure, and said fixed conductance element C2 is selected to accommodate a particular desired process chamber pressure range.

18. The gas flow device of claim 17, wherein said particular gas inlet pressure is approximately 5 psig.

19. The gas flow device of claim 13, wherein said first and second pressure reduction elements are demountable from the gas flow device assembly, and can replaceable by fixed or variable conductance elements having different conductance values.

20. The gas flow device of claim 13, wherein said throttle valve is a butterfly valve, and the position of said butterfly determines the gas conductance of said butterfly valve.

21. The gas flow device of claim 13, wherein said throttle valve is a metering valve, the setting of said metering valve determining the gas conductance of said metering valve.

22. A method for controlling the flow of gas from a gas source into a process chamber, the method comprising the steps of:
providing a gas flow device between the gas source and the process chamber, the gas flow device including:
an adjustable valve;
a pressure gauge disposed downstream of said adjustable valve;
a control system controlling the conductance of said adjustable valve based on an input signal from said pressure gauge, and
at least one pressure reduction element disposed one of upstream or downstream of said adjustable valve;
selecting a set point for the gas pressure measured at the pressure gauge;
measuring the actual pressure at the pressure gauge;
determining an error signal based on a difference between the set point and the measured actual pressure; and
adjusting the conductance of the adjustable valve based on the error signal determined.

23. The method of claim 22, wherein the set point is set by a user.

24. The method of claim 22, wherein the measuring, determining and adjusting steps operate in a closed-loop in order to minimize the error signal.
